(19) United States
(12) Patent Application Publication
(10) Pub. No.: US 2025/0012408 A1
(43) Pub. Date: Jan. 9, 2025

(54) FASTENING DEVICE AND VEHICLE

(71) Applicant: Scania CV AB, Södertälje (SE)

(72) Inventor: Walace CHICUTA, Mauá, São Paulo (BR)

(73) Assignee: Scania CV AB, Södertälje (SE)

(21) Appl. No.: 18/709,890

(22) PCT Filed: Nov. 22, 2022
(86) PCT No.: PCT/SE2022/051086

§ 371 Date: May 14, 2024

(30) Foreign Application Priority Data
Nov. 25, 2021 (SE) 2151436-9

(51) Int. Cl. F17C 13/08

(52) U.S. Cl. CPC F17C 13/085; F17C 2201/0104; F17C 2201/035; F17C 2221/012; F17C 2270/0171

(57) ABSTRACT

The disclosure concerns a fastening device configured for fastening a container to a vehicle. The fastening device comprises: a first band end and a second band end, a compression spring, an abutment for the compression spring, a tightening member, and an elongated element. The first band end, the second band end, the compression spring, and the abutment are arranged along a longitudinal axis of the elongated element. The abutment is displaceable by the tightening member along the longitudinal axis in a direction towards the first band end to compress the compression spring. The fastening device comprises a stop surface configured for preventing further displacement of the abutment when the abutment reaches a predetermined distance from the first band end.

### TECHNICAL FIELD

The invention relates to a fastening device configured for fastening a container to a vehicle. The invention further relates to a vehicle comprising a container and a fastening device.

### BACKGROUND

A container may be connected to a structure utilising a fastening device that includes a band arrangement connected to the structure. One or more bands of the fastening device may extend at least partially around the container.

One type of container connected to a structure in this manner may be a pressure vessel.

A tension in the one or more bands around at least part of the container ensures that the container is securely held by the one or more bands and thus, securely attached by the fastening device to the structure. A clamping force provided by the fastening device causes the tension in the one or more bands.

It may be difficult to provide an appropriate clamping force in a fastening device comprising one or more bands extending at least partially around a container.

One common fastening device provides a rigid fixation. Using such a fastening device, it is possible to control an initial clamping force. However, in case of a pressure vessel, a diameter of the pressure vessel i.e., the container increases as it is pressurized. Consequently, the clamping force and the tension in the one or more bands increase as well. Since the at least one band is of low elasticity, the clamping force increase steeply and puts considerable additional stress on the fastening device.

Such a steep increase in clamping force may be avoided in a different kind of known fastening device. This fastening device includes a spring and expands as a diameter of the container increases. Thus, the clamping force and the tension in the one or more bands only increases within a limited range of an initial force/tension as the container diameter increases.

However, the initial clamping force may be difficult to set for instance, at an assembly line and/or during service when reconnecting the container with the fastening device after having opened the fastening device.

### SUMMARY

It would be advantageous to achieve a fastening device overcoming, or at least alleviating, at least some of the above-mentioned drawbacks. In particular, it would be desirable to provide a fastening device that enables the application of an appropriate clamping force for securing a container. To better address one or more of these concerns, a fastening device and a vehicle having the features defined in the independent claims is provided.

According to an aspect of the invention, there is provided a fastening device configured for fastening a container to a vehicle. The fastening device comprises a band arrangement configured for extending at least partially around the container, the band arrangement comprising a first band end and a second band end. The fastening device further comprises a compression spring, an abutment for the compression spring, a tightening member, and an elongated element having a longitudinal extension along a longitudinal axis. The elongated element is connected to the first band end and extends towards and beyond the second band end. The abutment is arranged on the elongated element. The first band end, the second band end, the compression spring, and the abutment are arranged along the longitudinal axis. The compression spring is arranged between the second band end and the abutment. The second band end is arranged between the first band end and the compression spring. The abutment is displaceable by the tightening member along the longitudinal axis in a direction towards the first band end to compress the compression spring. The fastening device comprises a stop surface configured for preventing further displacement of the abutment when the abutment reaches a predetermined distance from the first band end.

Since the fastening device comprises the stop surface configured for preventing further displacement of the abutment when the abutment reaches a predetermined distance from the first band end, the compression spring can only be compressed a predetermined amount. Accordingly, it is ensured that a predetermined clamping force is provided by the fastening device.

More specifically, when fastening the container to the vehicle, the first and second band ends are arranged at least partially around the container and the tightening member is tightened such that the abutment is displaced to compress the compression spring. The stop surface ensures that the displacement of the abutment stops when the abutment reaches the predetermined distance from the first band end. Thus, a predetermined clamping force provided by the compression spring is always ensured when the tightening member is tightened.

In addition to the above, the present fastening device, inter alia since it provides the predetermined clamping force, may provide one or more of the following advantages: A more secure fastening device. No risk, or at least a minimal risk, to apply too large a clamping force, which could damage the band arrangement. No risk, or at least a minimal risk, to apply too small a clamping force, which could cause the fastening device to loosen e.g., due to vibrations. Reduce the cost of mounting a container with fastening device since the predetermined clamping force is easily and quickly applied in the present fastening device.

The fastening device, as defined above, is in an assembled but not finally tightened state, such as when positioned around a relevant container but prior to being tightened. Once the abutment has been displaced by the tightening member and compressed the compression spring, the abutment is positioned at the predetermined distance from the first band end.

Also, since the fastening device comprises the compression spring, the fastening device is configured for a limited increase in the clamping force in case the container is a pressure vessel, a diameter of which increases when a pressure inside the vessel increases.

Accordingly, the container may be a pressure vessel. The pressure vessel may be made from metal, such as steel, or from a composite material, such as a carbon fibre reinforced material. In the latter case, the pressure vessel may expand more when under pressure than in the case of a vessel made of metal.

The term container, however, is to be interpreted broadly and may include a tank, a vessel, a housing of a vehicle component such as a battery, a utility box, etc.

The fastening device may be configured for connecting the container to a chassis of a vehicle.

During mounting of the fastening device, tightening of the tightening member causes the abutment to be displaced towards the first band end and the fastening device to provide a clamping force around the container.

The band arrangement may comprise one band member, which in turn comprises the first and second band ends. Alternatively, the band arrangement may comprise a first and a second band member, the first band member comprising the first band end and the second band member comprising the second band end.

As mentioned above, the band arrangement is configured for extending at least partially around the container. Accordingly the length of the band arrangement is determined by the relevant container and optionally also by the relevant structure, to which the container is to be connected with the fastening device. Generally, a larger container may require a longer band arrangement than a smaller container.

A tension in the band arrangement ensures that the container is securely connected to the vehicle. A clamping force that causes the tension in the band arrangement is provided by the compression spring when the tightening member is tightened.

The compression spring, the abutment for the compression spring, the tightening member, and the elongated element are arranged to connect the first band end with the second band end.

Also, the compression spring, the abutment, the tightening member, and the elongated element are arranged to provide a clamping force between the first and second band ends when the tightening member is tightened during use of the fastening device.

More specifically, since the elongated element is connected to the first band end, the reaction force to the compression force of the compression spring when the tightening member is tightened, presses the second band end in a direction towards the first band end thus, provides the clamping force.

In accordance with different embodiments, the tightening member and elongated element may be devised in various ways as explained in further detail below.

During use of the fastening device, the compression spring is compressed between the second band end and the abutment. Put differently, the compression spring is configured to provide a separating force between the second band end and the abutment.

This is achieved by the above-mentioned displacement of the abutment by the tightening member along the longitudinal axis in the direction towards the first band end. Accordingly, in the same displacement the abutment is also displaced towards the second band end.

The first band end may be that end of the band arrangement closest to the second band end. Similarly, the second band end may be that end of the band arrangement closest to the first band end.

The predetermined distance from the first band end ensures that the compression spring is compressed to provide a predetermined clamping force when the fastening device is mounted at least partially around a container. However, the exact reference point for the predetermined distance is not of importance. What matters is that the compression spring always will be compressed to provide a predetermined clamping force i.e., that the clamping force applied is repeatable for each mounting of the fastening device.

The particular clamping force to be provided by the compression spring is determined for each particular construction case and depends inter alia on the relevant container to be connected by the fastening device and under what operating conditions the fastening device is used. Specifically, the reduction in length of the compression spring and the force constant of the compression spring determine the clamping force.

The abutment forms part of an element, a member, or similar that directly receives pressure from the compression spring when the tightening member is tightened.

In accordance with different embodiments, the stop surface may be provided in various ways as explained in further detail below.

According to embodiments, the second band end may be provided with an opening extending along the longitudinal axis. The elongated element may extend through the opening. In this manner, the second band end may be provided along the longitudinal axis which provides conditions for a compact and secure fastening device.

Accordingly, the compression spring may be aligned with the second band end to ensure an even distribution of the clamping force along the longitudinal axis.

According to some embodiments, the tightening member may comprise the elongated element and the tightening member may be threadedly connected at the first band end.

In such embodiments, the elongated element may be a screw extending along the longitudinal axis. In this manner, a simple and cost-efficient fastening device is provided capable of providing a predetermined clamping force in a quick and simple manner.

Alternatively, according to some embodiments, the tightening member may be threadedly engaged with the elongated element.

In such embodiments, the tightening member may be a nut configured to be threaded onto the elongated element, at an end portion thereof opposite to first the band end. In this manner, a simple and cost-efficient fastening device is provided capable of providing a predetermined clamping force in a quick and simple manner.

According to some embodiments, the fastening device may comprise a sleeve arranged concentrically around part of the elongated element, the sleeve having a shorter length along the longitudinal axis L than the elongated element. The sleeve may comprise the stop surface at an axial end thereof. In this manner, a length of the sleeve may be utilised for providing the predetermined distance from the first band end so as to obtain the predetermined clamping force in a quick and simple manner.

Alternatively, according to embodiments, the elongated element may comprise a diameter difference portion. The diameter difference portion may comprise the stop surface. In this manner, a length along the elongated element, starting at the diameter difference portion, may be utilised for providing the predetermined distance from the first band end.

According to embodiments, the fastening device may comprise a washer arranged concentrically with the longitudinal axis. The washer may comprise the abutment. In this manner, the abutment may be provided in a convenient manner.

Moreover, the provision of the abutment at the washer, and accordingly, the compression spring abutting against the washer may ensure that during tightening of the tightening member, torque is not transferred or at least transferred to a lesser degree to the compression spring. Thus, during tightening of the tightening member, the compression spring is substantially only subjected to a compressive force and at least to a lesser degree to torque and thus, not rotated.

According to a further aspect of the invention, there is provided a vehicle comprising a container, wherein the container is fastened to a chassis of the vehicle by a fastening device according to any one of aspects and/or embodiments discussed herein.

Thus, it is ensured that a predetermined clamping force is provided by the fastening device in a manner as discussed above.

Further features of, and advantages with, the invention will become apparent when studying the appended claims and the following detailed description.

### BRIEF DESCRIPTION OF THE DRAWINGS

Various aspects and/or embodiments of the invention, including its particular features and advantages, will be readily understood from the example embodiments discussed in the following detailed description and the accompanying drawings, in which:

FIG. 1 illustrates a vehicle according to embodiments,

FIGS. 2a-3b illustrate fastening devices according to embodiments,

FIG. 4 shows an exploded view of a fastening device according to embodiments, and

FIGS. 5a-7b illustrate cross sections through fastening devices according to embodiments.

### DETAILED DESCRIPTION

Aspects and/or embodiments of the invention will now be described more fully. Like numbers refer to like elements throughout. Well-known functions or constructions will not necessarily be described in detail for brevity and/or clarity.

FIG. 1 illustrates a vehicle 1 according to embodiments.

The vehicle 1 may be any kind of vehicle configured for land-based propulsion, such as e.g., a bus, a truck, a heavy truck, a car, or a train. In FIG. 1, the vehicle 1 is illustrated as a heavy load vehicle in the form of a truck.

The vehicle 1 comprises a container 4. The container 4 is secured to a chassis 3 of the vehicle 1 by at least one fastening device 2 according to any one of aspects and/or embodiments discussed herein.

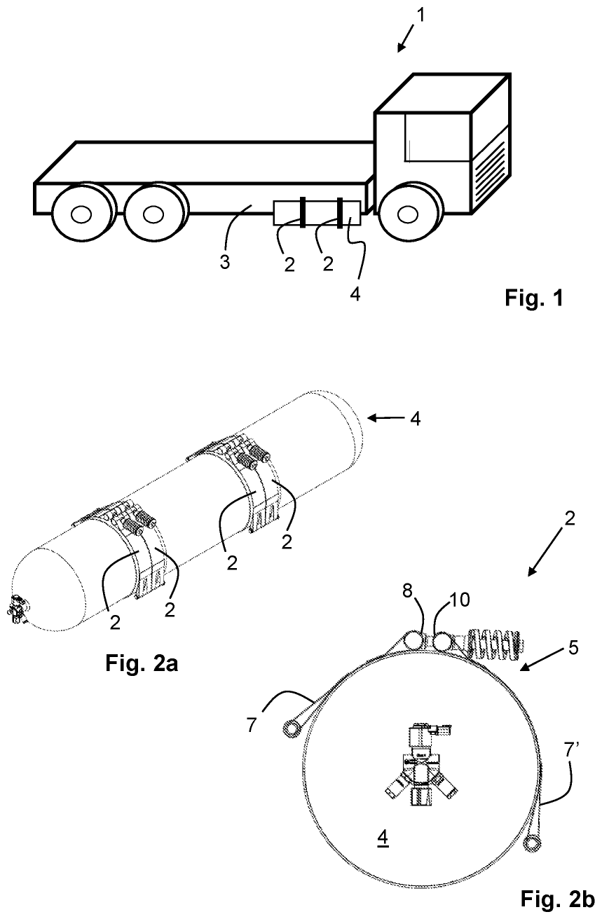

In the illustrated embodiments, the container 4 is secured to the chassis 3 with two fastening devices 2. Each of the fastening devices 2 may be a fastening device 2 in accordance with one of embodiments discussed below with reference to FIGS. 2-7b.

According to some embodiments, the container 4 may be a gas tank 4 configured for receiving and accommodating compressed gas. As discussed herein, the fastening device 2 is able to absorb an increase in gas tank 4 diameter, caused by an internal gas pressure in the gas tank 4, with a limited increase in a clamping force around at least part of the gas tank 4.

The gas in the gas tank 4 may be a gaseous fuel, such as natural gas or biogas, to be combusted in a combustion engine of the vehicle 1. Alternatively, the gas may be compressed air utilised e.g., in a brake system of the vehicle 1.

A further alternative is that the gas in the gas tank 4 may be a hydrogen fuel to be combusted in a combustion engine of the vehicle or to be supplied to a fuel cell for a reaction therein to provide electricity for an electrical vehicle.

According to alternative embodiments, the container 4 may be any other type of container connected to the cassis 3 of the vehicle 1, such as a battery box.

The number of fastening devices 2 used for connecting the container 4 to the chassis 3 may be selected in order to provide a secure fastening of the relevant container 4 and may depend on the size and weight of the container 4.

FIGS. 2a and 2b illustrate fastening devices 2 according to embodiments. FIG. 2a shows an isometric view of a container 4 secured to a non-shown structure by four fastening devices 2. FIG. 2b shows a side view of the container 4 with one fastening device 2 visible.

Depending on the relevant container to be secured to the structure, the number of fastening devices 2 may be other than four fastening devices 2.

In the embodiments of FIGS. 2a and 2b, each fastening devices 2 is of a first kind. Again, the fastening device 2 is utilised for securing a container 4, such as a gas tank 4, to a structure, such as a vehicle chassis.

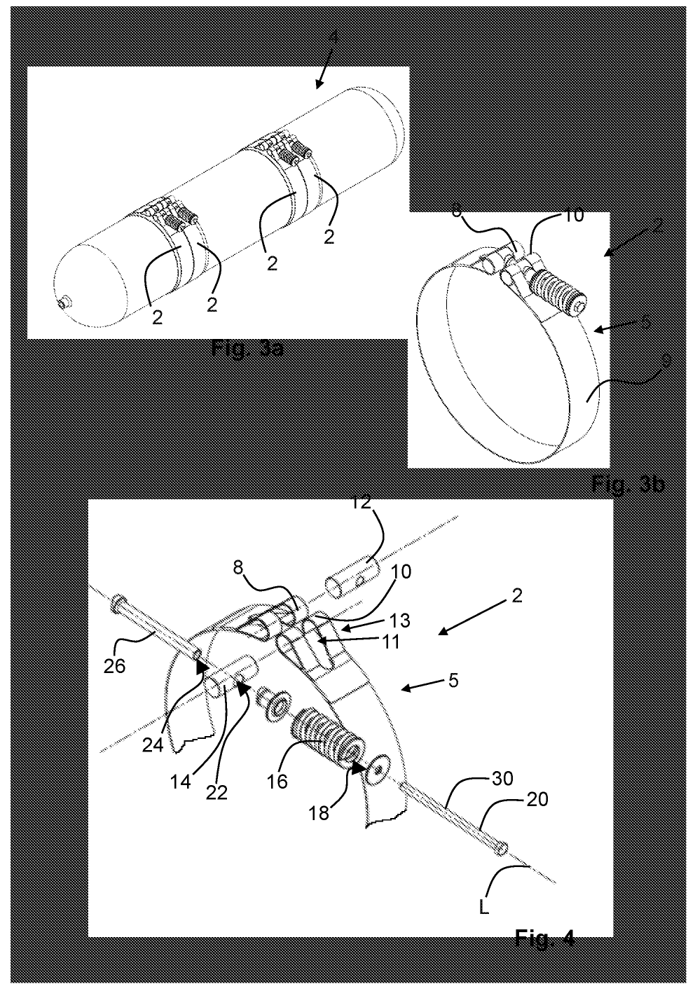

In the fastening device 2 of the first kind, a band arrangement 5 comprises separate first and second band members 7, 7′. The first band member 7 comprises a first band end 8. The second band member 7′ comprises a second band end 10, see further below with reference to FIGS. 4-7b.

FIGS. 3a and 3b illustrate fastening devices 2 according to embodiments. FIG. 3a shows an isometric view of a container 4 secured by four fastening devices 2. FIG. 3b shows a perspective view of one fastening device 2.

In the embodiments of FIGS. 3a and 3b, each fastening devices 2 is of a second kind. Again, the fastening device 2 is utilised for securing a container 4, such as a gas tank 4, to a non-shown structure, such as a vehicle chassis.

In the fastening device 2 of the second kind, a band arrangement 5 comprises one band member 9. The band member 9 comprises a first band end 8 and a second band end 10, see further below with reference to FIGS. 4-7b.

FIG. 4 shows an exploded view of a fastening device 2 according to embodiments. The fastening device 2 may be of the first kind discussed above with reference to FIGS. 2a and 2b or of the second kind discussed above with reference to FIGS. 3a and 3b.

Accordingly, the fastening device 2 is configured for fastening a container to a structure, such as a chassis of a vehicle and comprises a band arrangement 5 configured for extending at least partially around the container. The band arrangement 5 comprises a first band end 8 and a second band end 10.

The band arrangement 5 may be made from a metal, such as steel.

The fastening device 2 further comprises a compression spring 16, an abutment 18 for the compression spring 16, a tightening member 20, a stop surface 24, and an elongated element 30 having a longitudinal extension along a longitudinal axis L.

Various embodiments of the fastening device 2 including the above-mentioned features will be discussed in the following with reference to FIGS. 4-7b. In all embodiments, during use of the fastening device 2, a predetermined clamping force is provided by the fastening device 2. This is due to the provision of the stop surface 24, which is configured for preventing further displacement of the abutment 18 as it reaches a predetermined distance from the first band end 8, when the abutment 18 is displaced by the tightening member 20 to compress the compression spring 16. Thus, the compression spring 16 can only be compressed a predetermined amount to provide the predetermined clamping force.

Such a predetermined amount of compression of the compression sprig 16 is provided as the fastening device 2 is assembled and tightened around a relevant container.

When the container is a pressure vessel, a diameter and circumference thereof increase as the pressure inside the container increases. The clamping force provided by the compression spring increases depending on the increase in circumference of the container and the force constant of the compression spring 16.

With reference to FIGS. 4-7b, and the embodiments disclosed therein, the first band end 8, the second band end 10, the compression spring 16, the abutment 18 for the compression spring 16, the tightening member 20, the stop surface 24, and the elongated element 30 are arranged in the following manner:
The elongated element 30 is connected to the first band end 8 and extends towards, and beyond the second band end 10.
The abutment 18 is arranged on the elongated element 30.
The first band end 8, the second band end 10, the compression spring 16, and the abutment 18 are arranged along the longitudinal axis L.
The compression spring 16 is arranged between the second band end 10 and the abutment 18.
The second band end 10 is arranged between the first band end 8 and the compression spring 16.

Moreover, the abutment 18 is displaceable by the tightening member 20 along the longitudinal axis L in a direction towards the first band end 8 to compress the compression spring 16.

More specifically, the compression spring 16 is compressed between the second band end and the abutment 18.

The compression spring 16 may be arranged directly at the second band end 10 or at a distance from the second band end 10 e.g., at a distance as provided by one or more members and/or elements as discussed below.

The elongated element 30 may be directly or indirectly connected to the first band end 18.

Furthermore, as mentioned above, the fastening device 2 comprises the stop surface 24, which is configured for preventing further displacement of the abutment 18 when the abutment 18 reaches a predetermined distance D from the first band end 8 during mounting of the fastening device 2.

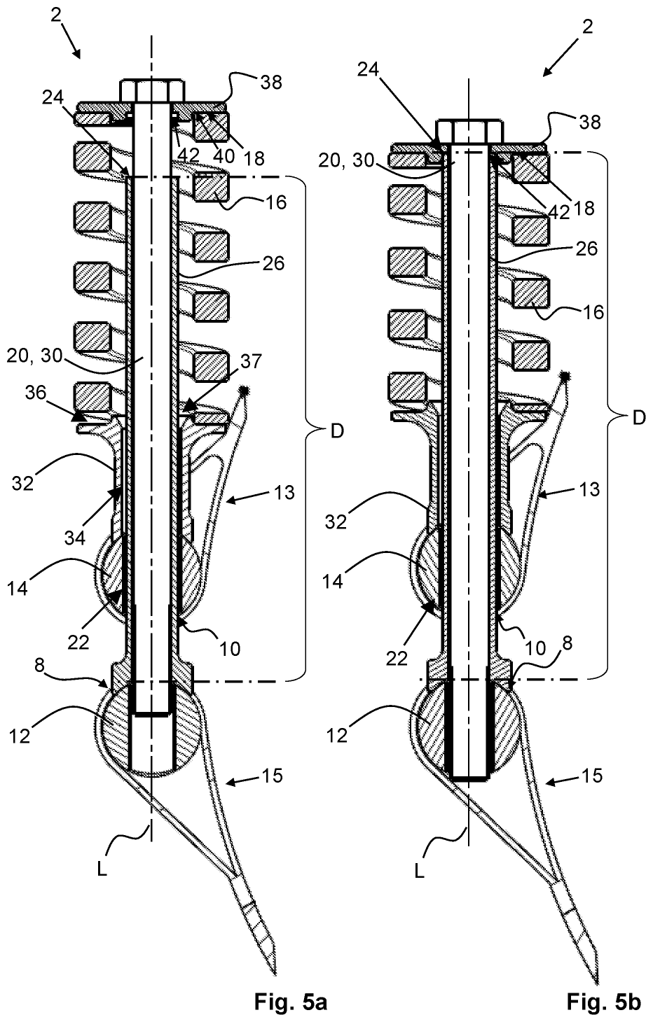

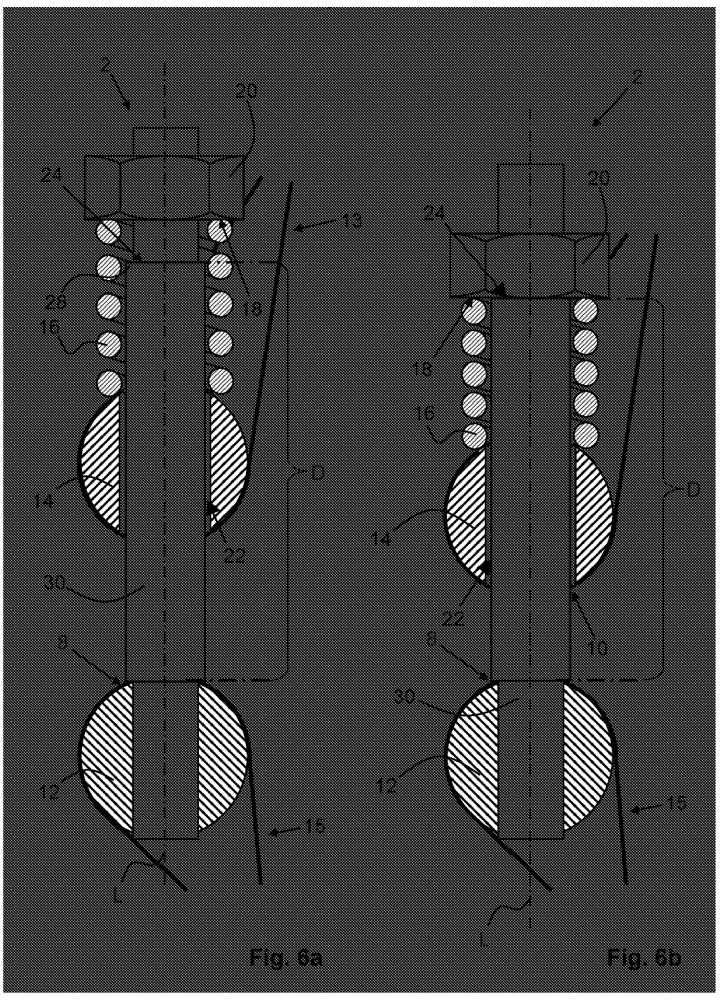

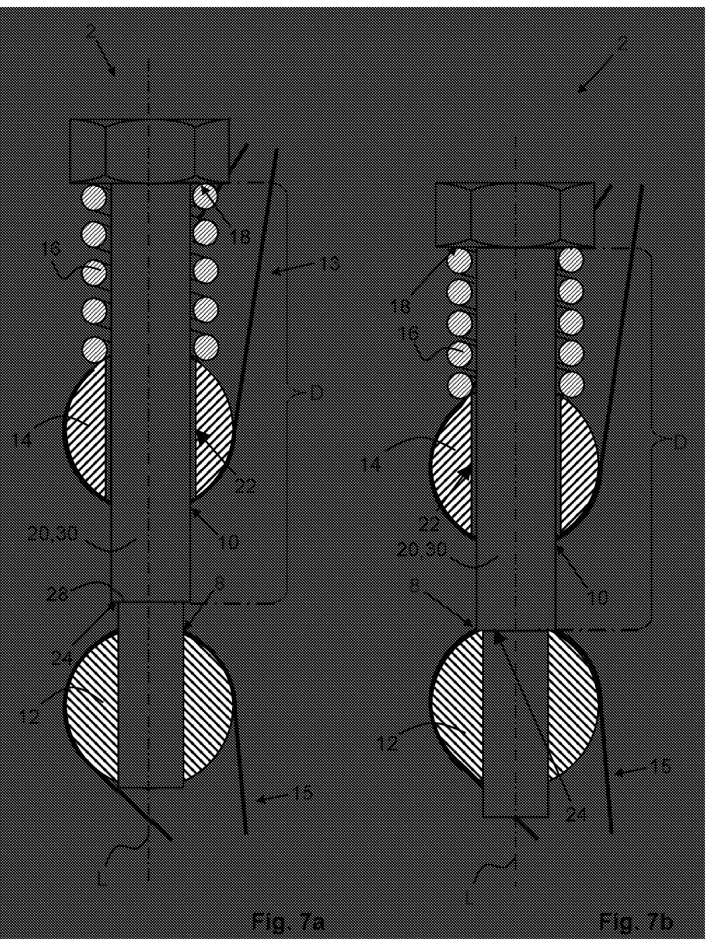

According to some embodiments, the stop surface 24 may be provided at an axial end of a sleeve 26, as illustrated in FIGS. 4, 5a, and 5b. According to some embodiments, the stop surface 24 may be provided at a diameter difference portion 28 of the elongated element 30, as illustrated in FIGS. 6a-7b.

According to some embodiments, the tightening member 20 may comprise the elongated element 30, as illustrated in FIGS. 4, 5a, 5b, 7a, and 7b. According to some embodiments, the tightening member 20 may be threadedly engaged with the elongated element 30, as illustrated in FIGS. 6a and 6b.

Example embodiments and their particulars will be discussed in the following with reference to FIGS. 4 and 5a-7b.

The elongated element 30 may be connected to the first band end 8 in any suitable manner.

In the illustrated embodiments, a securing member 12 in the form of a cylinder extending with its axis perpendicularly to the longitudinal axis L of the elongated element 30 is arranged in a sling 15 of the band arrangement 5. The sling 15 being arranged at the first band end 8.

The elongated element 30 is connected to the securing member 12 e.g., by a threaded connection between the elongated element 30 and the securing member 12.

One alternative may be for the elongated element 30 to be connected with a nut at the first band end 8 e.g., by arranging the nut along the longitudinal axis 30 and securing it at the first band end 8 possibly using further elements.

As clearly visible in the exploded view of FIG. 4, the second band end 10 may be provided with an opening 11 extending along the longitudinal axis L. The elongated element 30 extends through the opening 11.

The opening 11 provides for the elongated element 30 to extend through the second band end 10 and thus, for the second band end 10 to be arranged at a level of the longitudinal axis L. Accordingly, the second band end 10 may be arranged along the longitudinal axis L.

A guiding member 14 may be provided at the second band end 10. The guiding member 14 may be arranged in a sling 13 at the second band end 10 of the band arrangement 5.

The guiding member 14 may be provided with a through hole 22 having an axis aligning with the longitudinal axis L. Thus, the elongated element 30 may extend through the through hole 22.

Accordingly, besides being arranged between the second band end 10 and the abutment 18, the compression spring 16 may be arranged between the guiding member 14 and the abutment 18.

The guiding member 14 may be provided in the form of a cylinder extending with its axis perpendicularly to the longitudinal axis L.

FIGS. 5a and 5b illustrate cross sections through a fastening device 2 according to embodiments. In FIG. 5a the compression spring 16 is schematically shown in an un-compressed state and in FIG. 5b the compression spring 16 is schematically shown in a compressed state. These embodiments are also shown in FIG. 4. Accordingly, in the following reference is also made to FIG. 4.

In these embodiments, the tightening member 20 comprises the elongated element 30 and the tightening member 20 is threadedly connected to the first band end 8. For instance, the tightening member 20 may be threadedly connected with the securing member 12 to the first band end 8.

Accordingly, the tightening member 20 may be a screw.

As mentioned above, in these embodiments, the fastening device comprises a sleeve 26 arranged concentrically around part of the elongated element 30.

The sleeve 26 may be slidingly arranged on the elongated element 30.

The sleeve 26 has a shorter length along the longitudinal axis L than the elongated element 30. The sleeve 26 comprises the stop surface 24 at an axial end thereof.

Accordingly, when during mounting of the fastening device 2, the abutment 18 is displaced by the tightening member 20 along the longitudinal axis L in a direction towards the first band end 8 and the compression spring 16 is gradually compressed, the stop surface 24 prevents further displacement of the abutment 18 when the abutment 18 reaches the predetermined distance D from the first band end 8.

More specifically, the sleeve 26 is arranged to remain in a specific position along the longitudinal axis L in relation to the first band end 8. That is, an axial end of the sleeve 26 opposite to the axial end being provided with the stop surface 24, cannot be displaced in a direction away from the compression spring 16 beyond a predetermined axial position at the first band end 8. For instance, the sleeve 26 may abut against the first band end 8 or against the securing member 12. Alternatively, the sleeve 26 as such may be fixed to the first band end 8.

Thus, inter alia the length of the compression spring 16, the force constant of the compression spring 16, and the length of the sleeve 26 determine the clamping force provided by the fastening device 2.

According to embodiments, the fastening device 2 may comprising a distance element 32 arranged between the second band end 10 and the compression spring 16. The distance element 32 may be provided with a through hole 34 arranged along the longitudinal axis L, and the elongated element 30 may extend through the through hole 34. In this manner, the distance element 32 may position the compression spring 16 in a suitable position along the longitudinal axis L in relation to the second band end 10.

Suitably, in embodiments comprising the sleeve 26, also the sleeve 26 extends through the through hole 34. The sleeve 26 may be slidingly received in the through hole 34 of the distance element 32.

According to embodiments, the distance element 32 may be provided with a circumferential recess 36 concentrically with the longitudinal axis L, the circumferential recess 36 being arranged for receiving an end of the compression spring 16. In this manner, the distance element 32 may provide a seat for the compression spring 16. Thus, a concentric position of the compression spring 16 in relation to the longitudinal axis L may be provided.

In the illustrated embodiments, the circumferential recess 36 is provided in a radially extending surface of the distance element 32.

According to embodiments, the distance element 32 may be provided with a funnel-shaped recess 37 at the through hole 34. In this manner, the elongated element 30 and/or the sleeve 26 may be guided into the further through hole 34 during assembly of the fastening device 2.

The funnel-shaped recess 37 may be provided at an axial end of the distance element 32 facing towards the compression spring 16 and the abutment 18.

In these embodiments, the fastening device 2 comprises a washer 38 arranged concentrically with the longitudinal axis L. The washer 38 comprises the abutment 18.

According to embodiments, the abutment 18 may be provided at a circumferential recess 40 of the washer 38, the circumferential recess 40 of the washer 40 being arranged for receiving an end of the compression spring 16. In this manner, the washer 38 may provide a seat for the compression spring 16. Thus, a concentric position of the compression spring 16 in relation to the longitudinal axis L may be provided at the abutment 18.

According to embodiments, the washer 38 may be provided with a further circumferential recess 42 concentrically with the longitudinal axis L, the further circumferential recess 42 of the washer 38 being arranged for receiving an end of the sleeve 26. In this manner, a seat for the sleeve 26 may be provided at the washer 38 with a concentric position of the sleeve 26 in relation to the longitudinal axis L.

More specifically, when the tightening member 20 has been tightened to compress the compression spring 16 with the abutment 18 at the predetermined distance D from the first band end 8, as shown in FIG. 5b, the stop surface 24 at the axial end of the sleeve 26 abuts against the washer 38 in the further circumferential recess 42.

FIGS. 6a and 6b illustrate cross sections through a fastening device 2 according to embodiments. In FIG. 6a the compression spring 16 is schematically shown in an un-compressed state and in FIG. 6b the compression spring 16 is schematically shown in a compressed state.

In these embodiments, the tightening member 20 is threadedly engaged with the elongated element 30.

Accordingly, the tightening member 20 may be a nut and the elongated element 30 may be provided with treads for receiving the nut at an axial end of the elongated element 30 opposite to the first band end 8.

The elongated element 30 comprises a diameter difference portion 28. The diameter difference portion 28 comprises the stop surface 24.

The diameter difference portion 28 is provided at an end portion of the elongated element 30 opposite to the first band end 8.

A length along the elongated element 30, between the first band end 8 and the diameter difference portion 28, provides the predetermined distance D from the first band end 8.

During mounting of the fastening device 2, the tightening member 20 is threaded onto the elongated element 30 to compress the compression spring 16 until the stop surface 24 at the diameter difference portion 28 prevents further displacement of the abutment 18.

Accordingly, when during mounting of the fastening device 2, the abutment 18 is displaced by the tightening member 20 along the longitudinal axis L in a direction towards the first band end 8 and the compression spring 16 is gradually compressed, the stop surface 24 prevents further displacement of the abutment 18 when the abutment 18 reaches the predetermined distance D from the first band end 8.

Thus, inter alia the length of the compression spring 16, the force constant of the compression spring 16, and the predetermine distance D determine the clamping force provided by the fastening device 2.

According to embodiments, the tightening member 20 may comprise the abutment 18. In this manner, a radially extending surface of the tightening member 20, i.e. of the nut, may form the abutment 18.

In a similar manner to the washer 38 discussed above with reference to FIGS. 5a and 5b, the abutment 18 may be provided at a circumferential recess (not shown) of the tightening member 20, the circumferential recess of the tightening member 20 being arranged for receiving an end of the compression spring 16.

According to some embodiments, a sleeve may be provided instead of the diameter difference. That is, an elongated element 30 without a diameter difference may be provided in an embodiment comprising the threadedly engaged tightening member 20 as discussed with reference to FIGS. 6a and 6b, in combination with a sleeve 26 providing a stop surface 24 as discussed with reference to FIGS. 4-5b.

According to some embodiments, a distance member 32 as discussed above with reference to FIGS. 5a and 5b may be provided in the embodiments comprising the elongated element and the threadedly engaged tightening member 20 as discussed with reference to FIGS. 6a and 6b.

FIGS. 7a and 7b illustrate cross sections through a fastening device 2 according to embodiments. In FIG. 7a the compression spring 16 is schematically shown in an un-compressed state and in FIG. 7b the compression spring 16 is schematically shown in a compressed state.

Similar to the embodiments of FIGS. 4-5b, the tightening member 20 comprises the elongated element 30. Accordingly, again the tightening member 20 may be a screw.

In these embodiments, the elongated element 30 comprises a diameter difference portion 28. The diameter difference portion 28 comprise the stop surface 24.

The diameter difference portion 28 is provided at an end portion of the elongated element 30 at the first band end 8.

Thus, during mounting of the fastening device 2, the tightening member 20/elongated element 30 is threadedly engaged with at the first band end 8 e.g., with the securing member 12 to compress the compression spring 16 until the stop surface 24 at the diameter difference portion 28 prevents further displacement of the abutment 18.

A length between the abutment 18 at the head of the screw and the diameter difference portion 28 provides the predetermined distance D from the first band end 8, when the tightening member 20 has been fully threadedly engaged at the first band end 8 such that the stop surface 24 abuts at the first band 8 e.g., against the securing member 12.

Accordingly, when during mounting of the fastening device 2, the abutment 18 is displaced by the tightening member 20 along the longitudinal axis L in a direction towards the first band end 8 and the compression spring 16 is gradually compressed, the stop surface 24 prevents further displacement of the abutment 18 when the abutment 18 reaches the predetermined distance D from the first band end 8.

Thus, inter alia the length of the compression spring 16, the force constant of the compression spring 16, and the predetermine distance D determine the clamping force provided by the fastening device 2.

According to embodiments, the tightening member 20 may comprise the abutment 18. In this manner, a radially extending surface of tightening member 20, i.e. a head of the screw, may form the abutment 18.

According to some embodiments, a distance member 32 as discussed above with reference to FIGS. 5a and 5b may be provided in the embodiments comprising the tightening member as discussed with reference to FIGS. 6a and 6b.

Various features of the embodiments of FIGS. 4-7b may be combined in other ways than discussed above. For instance a washer 38 with the abutment 18 may be provided in the embodiments of FIGS. 6a-7b instead of providing the abutment 18 at the tightening member 20. The fastening device 2 according to the embodiments herein may be assembled to a vehicle 1 by an assembler or an assembling machine to hold a container 4 relative to the vehicle 1.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

1. A fastening device configured for fastening a container to a vehicle, the fastening device comprising:
a band arrangement being configured for extending at least partially around the container, the band arrangement comprising a first band end and a second band end;
a compression spring;
an abutment for the compression spring;
a tightening member; and
an elongated element having a longitudinal extension along a longitudinal axis, the elongated element being connected to the first band end and extending towards and beyond the second band end,
wherein the abutment is arranged on the elongated element,
wherein the first band end, the second band end, the compression spring, and the abutment are arranged along the longitudinal axis,
wherein the compression spring is arranged between the second band end and the abutment,
wherein the second band end is arranged between the first band end and the compression spring,
wherein the abutment is displaceable by the tightening member along the longitudinal axis in a direction towards the first band end to compress the compression spring, and
wherein the fastening device comprises a stop surface configured for preventing further displacement of the abutment when the abutment reaches a predetermined distance from the first band end.

2. The fastening device according to claim 1, wherein the second band end is provided with an opening extending along the longitudinal axis, wherein the elongated element extends through the opening.

3. The fastening device according to claim 2, wherein the tightening member comprises the elongated element, and wherein the tightening member is threadedly connected at the first band end.

4. The fastening device according to claim 2, wherein the tightening member is threadedly engaged with the elongated element.

5. The fastening device according to claim 2 further comprising a sleeve arranged concentrically around part of the elongated element, wherein the sleeve has a shorter length along the longitudinal axis than the elongated element, and wherein the sleeve comprises the stop surface at an axial end thereof.

6. The fastening device according to claim 2, wherein the elongated element comprises a diameter difference portion, and wherein the diameter difference portion comprises the stop surface.

7. The fastening device according to claim 2 further comprising a distance element arranged between the second band end and the compression spring, wherein the distance element is provided with a through hole arranged along the longitudinal axis, and wherein the elongated element extends through the through hole.

8. The fastening device according to claim 7, wherein the distance element is provided with a circumferential recess concentrically with the longitudinal axis, the circumferential recess being arranged for receiving an end of the compression spring.

9. The fastening device according to claim 7, wherein the distance element is provided with a funnel-shaped recess at the through hole.

10. The fastening device according to claim 1 further comprising a washer arranged concentrically with the longitudinal axis, wherein the washer comprises the abutment.

11. The fastening device according to claim 10, wherein the abutment is provided at a circumferential recess of the washer, the circumferential recess of the washer being arranged for receiving an end of the compression spring.

12. The fastening device according to claim 11,
wherein the fastening device further comprises a sleeve arranged concentrically around part of the elongated element, wherein the sleeve has a shorter length along the longitudinal axis than the elongated element, and wherein the sleeve comprises the stop surface at an axial end thereof, and
wherein the washer is provided with a further circumferential recess concentrically with the longitudinal axis, the further circumferential recess of the washer being arranged for receiving an end of the sleeve.

13. The fastening device according to claim 1, wherein the tightening member comprises the abutment.

14. A vehicle comprising configured for fastening a container to the vehicle, the fastening device comprising:
a band arrangement being configured for extending at least partially around the container, the band arrangement comprising a first band end and a second band end;
a compression spring;
an abutment for the compression spring;
a tightening member; and
an elongated element having a longitudinal extension along a longitudinal axis, the elongated element being connected to the first band end and extending towards and beyond the second band end,
wherein the abutment is arranged on the elongated element,
wherein the first band end, the second band end, the compression spring, and the abutment are arranged along the longitudinal axis,
wherein the compression spring is arranged between the second band end and the abutment,
wherein the second band end is arranged between the first band end and the compression spring,
wherein the abutment is displaceable by the tightening member along the longitudinal axis in a direction towards the first band end to compress the compression spring, and
wherein the fastening device comprises a stop surface configured for preventing further displacement of the abutment when the abutment reaches a predetermined distance from the first band end.

15. The vehicle according to claim 14 further comprising a container fastened to a chassis of the vehicle by the fastening device, wherein the container is a gas tank configured for receiving and accommodating compressed gas.

16. The vehicle according to claim 14, wherein the second band end is provided with an opening extending along the longitudinal axis, wherein the elongated element extends through the opening.

17. The vehicle according to claim 16, wherein the tightening member comprises the elongated element, and wherein the tightening member is threadedly connected at the first band end.

18. The vehicle according to claim 16, wherein the tightening member is threadedly engaged with the elongated element.

19. The vehicle according to claim 16 further comprising a sleeve arranged concentrically around part of the elongated element, wherein the sleeve has a shorter length along the longitudinal axis than the elongated element, and wherein the sleeve comprises the stop surface at an axial end thereof.

20. The vehicle according to claim 16, wherein the elongated element comprises a diameter difference portion, and wherein the diameter difference portion comprises the stop surface.
